(19) United States
(12) Patent Application Publication
(10) Pub. No.: US 2007/0043486 A1
(43) Pub. Date: Feb. 22, 2007

(54) Rail wheel measurement

(76) Inventors: Jeffrey Paul Moffett, Wattsburg, PA (US); Jason Keanuenue Yamato Miyashiro, Keller, TX (US); Sivakumar Subramaniam, Lee's Summit, MO (US); Jeffrey Richard Brooks, Shawnee, KS (US); Anthony M. Tomaro, Sagamore Hills, OH (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 11/206,960

(22) Filed: Aug. 18, 2005

(51) Int. Cl. G06F 19/00

(52) U.S. Cl. 701/29; 701/19

(57) ABSTRACT

A method of determining a remaining service life for a rail wheel (18) of a railway vehicle using an electronic rail wheel (18) wear gauge (10) mountable on the rail wheel for measuring at least one rail wheel dimension. The method includes measuring a rail wheel dimension and processing the measured wheel dimension relative to an allowable wear dimension. The method also includes accessing a historical wheel wear rate database (44) relating to the rail wheel and predicting a remaining service life of the wheel based on the historical wheel wear rate data and the processed wheel dimension.

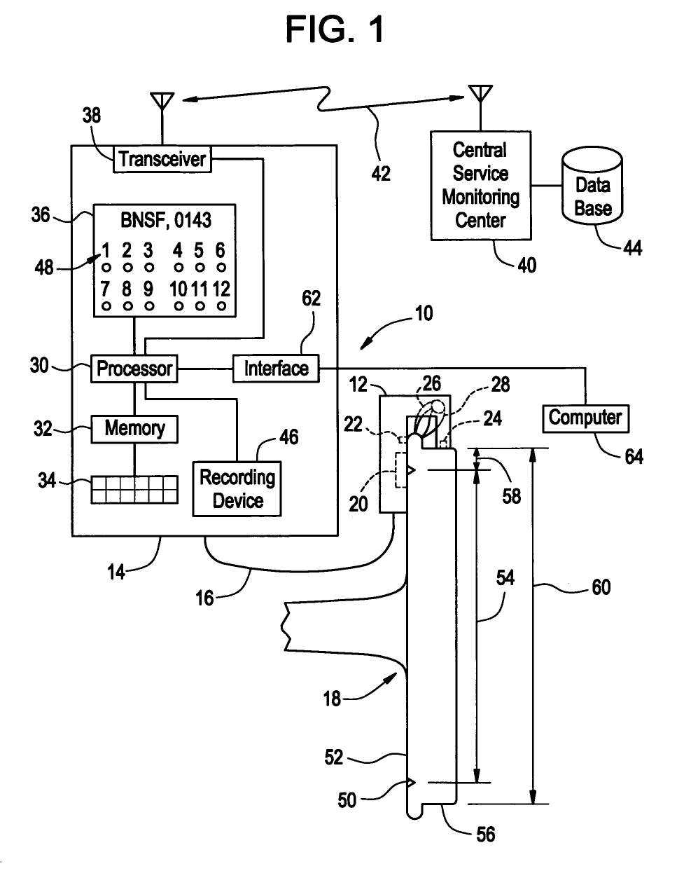

### FIELD OF THE INVENTION

This invention relates generally to the field of rail transportation and, more particularly, to an electronic device for measuring rail wheel dimensions.

### BACKGROUND OF THE INVENTION

A typical train includes one or more locomotives pulling a plurality of load cars. Each vehicle in the train includes a plurality of steel wheels that roll along the metal rail as the train is propelled along the track. Proper interaction between the wheel and the rail is critical for safe, reliable, efficient operation of the train.

A rail includes a bottom mounting flange, a top railhead that makes contact with the vehicle wheel, and a flange interconnecting the flange and the railhead. A vehicle wheel includes a center hub mounted onto the vehicle axle, a plate extending outwardly from the hub, and an outer rim surrounding the plate for making contact with the rail. The rim includes an outside diameter tread that may be flat or tapered and a flange extending outwardly from a back side of the tread. The tread rides along a top surface of the railhead for supporting the vertical weight of the vehicle. The flange extends along and makes contact with a side of the railhead for providing lateral support to allow the wheel to follow along the path of the railhead. Flanges are provided on only one side of each wheel along an inside of the rail. Rail vehicle wheels suffer wear over time due to their contact with the rail. The treads wear as a result of their contact with the top of the rail, particularly in the event of the wheel slipping with respect to the rail during acceleration or braking events. The wheel flanges will wear due to their contact with the inside surface of the railhead, particularly on curves and through switches. Consequently, rail wheel wear must be monitored to ensure that dimensions of the wheel subject to wear are sufficient for continued safe use. In the past, rail wheel dimensions were periodically measured using a Federal Railway Administration (FRA) approved mechanical gauge. More recently, mechanical gauges have been replaced with electronic gauges that provide more accurate and repeatable rail wheel measurements. One such electronic rail wheel gauge measurement device is described in U.S. Pat. No. 4,904,939 and is incorporated herein by reference. The electronic rail wheel gauge described in the '939 patent includes sensors for determining proper positioning on the wheel and to measure rail wheel dimensions such as rim thickness, flange thickness, flange height, and a rim diameter of a train wheel.

### BRIEF DESCRIPTION OF THE DRAWINGS

The sole FIGURE shows a schematic diagram of an exemplary embodiment of an improved electronic rail wheel measurement gauge.

### DETAILED DESCRIPTION OF THE INVENTION

The use of electronic rail wheel gauges to measure various rail wheel dimensions has allowed more accurate and repeatable measurements to be achieved compared to using conventional mechanical rail wheel measurement gauges. However, the rail wheel measurement information providing using electronic rail wheel gauges has been underutilized for making rail wheel service decisions, such as predicting remaining wheel life. In the past, rail wheel service decisions may have been made based on a measured dimension's proximity to a minimum dimension size, for example, as specified by the FRA, without regard for a wear rate of the measured wheel or measurement interval. However, such techniques may allow useable wheel wear life to be sacrificed. The inventors of the present invention have innovatively realized that information derived from electronic rail wheel measurements may be used in conjunction with historical information related to the wheel being measured to more accurately predict a remaining service life of the measured wheel. An improved rail wheel measurement gauge allows a user to enter certain types of data and draw conclusions based on that data for making rail wheel servicing decisions. Advantageously, a remaining future life available for a measured wheel may be projected using an event driven determination rather than a conventional scheduled repair or replacement technique. For example, by being able to access historical operating conditions of locomotive undergoing wheel measurements, the remaining future life of the wheels of the locomotive may be better predicted based on a remaining measured dimension being sufficiently far away from a minimum dimension.

The FIGURE shows a schematic diagram of an exemplary embodiment of an improved electronic rail wheel measurement gauge 10. The rail wheel measurement gauge 10 may include a gauge head 12 for removably mounting on a rail wheel 18. The gauge head 12 may be in communication with a controller 14, for example, via hardwired connection 16. In another embodiment, the gauge head 12 and controller 14 may be combined in a single unit.

The gauge head 12 may include one or more sensors for measuring rail wheel dimensions and providing measurement information to the controller 14. For example, the sensors may include a reference groove position sensor 20, gauge head positioning sensors 22, 24, a rail wheel flange height sensor 26, and a rail wheel flange thickness sensor 28.

The controller 14 may include a processor 30 in communication with the gauge head 12, a memory 32, an input device 34, and a display 36. The input device 34 allows a user to input information, such as an AAR designation and/or road number, to identify a locomotive having its wheels measured. The controller 14 may also include a transceiver 38 for transmitting and receiving information from a centralized location, such as a central service monitoring center 40 remote from the gauge 10. The transceiver 38 may operate using RF transmission techniques, such as a radio or cellular link. In another embodiment, the transceiver 38 may operate using web enabled techniques, such as by using WiFi or Bluetooth transmission protocols.

An interface 62, such as an RS-232 interface, may be provided for connecting to a computer 64 for uploading and or downloading information. The computer may function as an intermediary between the gauge 10 and the central service monitoring center 40, for example, via an Internet connection between the computer 64 and the central service monitoring center 40.

The processor 30 may be configured for receiving respective measured wheel dimension measurement data from the sensors and for processing the respective measured wheel dimensions relative to an allowed dimension, for example, stored in a look up table in memory 32. The processor 30 may be further configured for predicting a remaining service life of the measured wheel 18 based on a historical wear rate of the wheel and a measured wheel dimension provided by a respective sensor 20, 26, 28. For example, the historical wear rate may be derived from an actual wear rate of the wheel being measured and a projected rate based on future wear at the same wear rate. In another aspect, the historical wear rate may be derived from an expected future service life of the wheel 18, such as whether the wheel 18 is expected to be subject to long haul freight operations or short haul operations that may result in a higher wear rate than long haul operations. For example, rail wheel wear may be measured at periodic timed intervals during its service life and historical wear rate data for the wheel may be developed based on these rail wheel specific periodic measurements. In another aspect, the rail wheel is from a population of generally similar rail wheels, wherein the population is measured at timed intervals to develop the historical wheel wear rate database applicable to wheel in the population.

In an embodiment, the historical information may be input via the input device 34 by a user having knowledge of the historical wheel operating conditions. In another embodiment, the historical information may be downloaded from a remote site, such as by accessing a database 44 of the central service monitoring center 40 via communication link 42. The locomotive having its wheel 18 measured may be referenced by its AAR designation and/or road number to retrieve the corresponding historical data from the central service monitoring center 40 or other data sources.

In another aspect, the measured wheel dimension data may be stored in memory 32 and corresponding rail wheel dimension information may be uploaded to the central service monitoring center 40. Prediction of the remaining service life of the wheel 18 may be performed remote from the gauge 10, for example, at the central service monitoring center 40, based on rail wheel dimension information transmitted from the gauge 10 to the central service monitoring center 40 and the historical knowledge of the wheel's use, for example, stored in a database 44 accessible by the central service monitoring center 40.

In another embodiment, the controller 14 may be configured for receiving an operator identifier to identify a user of the gauge 10, such as via the input device 34, to allow recording the user performing a measurement, so that a measurement may be associated with a specific user. In another aspect, the controller 14 may include a recording device 46, such as voice recorder or a camera, for allowing the user to record information indicative of rail wheel wear observed by the user. For example, when performing measurements on a rail wheel 14, a user may notice a flat spot in the wheel 18 and may input this information into the memory 32 of the controller 14 via the recording device 46. Such observed information may also be input via the input device 34.

The display 36 may include indicia 48 helpful to a user for performing measurement tasks, such as indicia 48 indicative of a sequence of rail wheel measurements to be performed. For example, when measuring the wheels of a twelve wheel locomotive, the display 36 may show indicia 48 indicative of the twelve wheels and the sequence of measuring each of the twelve wheels to help insure that the operator measures the wheels according to the desired sequence.

In another embodiment, the processor 30 of the controller 14 may be configured for determining remaining rail wheel service life based on measurements made with reference to an annular reference groove 50 formed in a face 52 of the wheel 18. The processor 30 may be further configured for receiving a reference groove dimension indicative of the diameter 54 of a reference groove 50 of the rail wheel being measured. For example, a look up table may be provided in memory 32 that correlates types of locomotives or types of wheels with a corresponding rail wheel reference groove diameter 54 dimension. Accordingly, the user may input the type of locomotive being measured into the processor 30, for example, via input device 34, and the processor 30 associates the input locomotive type with the appropriate rail wheel reference groove diameter 54. In another embodiment, rail wheel reference groove diameter information may be stored remote from the gauge 10, such as in the database 44 of the central service monitoring center 40. When a user enters a type of locomotive or type of wheel, the processor 30 may query the central service monitoring center 40 via transmitter 38 to acquire the appropriate reference groove diameter information. In yet another embodiment, the user may input the reference groove diameter 54 directly via input device 34 if it is known, such as by measuring the reference diameter 54.

In an embodiment, the reference groove sensor 20 provides measurement data relative to the reference groove 50 and the rim 56 of the wheel 18, such as a reference groove-to-rim distance 58. The processor 30 receives this data from the reference groove sensor 20 and calculates a wheel diameter 60 based on a measured distance and, for example, an input reference groove diameter 54, so that the diameter 60 of the wheel may be calculated as reference groove diameter 54 plus two times the reference groove to rim distance 58. This calculated diameter 60 may then be used to predict the remaining service life of the wheel 18 as described previously. In an aspect of the invention, the sensor 20 may comprise a rail wheel reference groove locator sensitive to a location of the rail wheel reference groove relative to a position of the gauge head 12 when the gauge head 12 is installed on the wheel. In an embodiment, the sensor 20 may include an eddy current device.

In another aspect of the invention, rail wheels 18 removed from locomotives may be associated with the locomotives from which they were removed by certain identifiers, such as service order invoice numbers. The controller 14 may be configured for receiving a rail wheel identifier, such as a service invoice number, input via the input device 34, for associating the removed rail wheel 18 to be serviced with the service order invoice number. Accordingly, the wheel 18 being serviced may be linked to a locomotive from which the wheel was removed. Advantageously, the gauge 10 may be used to ensure that wheels 18 removed from locomotives are being properly scheduled for maintenance. By associating a removed rail wheel 18 with a service invoice to link the wheel 18 to the locomotive from which the wheel 18 was removed, a decision to have the wheel 18 serviced may be traced back to a service decision point, such as a locomotive service center where the invoice was generated. The gauge 10 may be used at a wheel servicing center to perform a second measurement on a removed wheel 18 having been previously measured and determined to need servicing to verify that the removed wheel 18 did indeed need servicing. If the second measurement performed at the wheel serving center reveals that the wheel 18 still had available service life, for example, based on a historical wear rate, this information can be noted and flagged to be used for quality control purposes. For example, the information may be uploaded from the gauge 10 to the central processing center 40 for notifying the locomotive service center where the decision to service the wheel 18 was made that the service decision was made prematurely.

Based on the foregoing specification, the methods described may be implemented using computer programming or engineering techniques including computer software, firmware, hardware or any combination or subset thereof, wherein the technical effect is to provide an improved electronic device for measuring rail wheel dimensions. Any such resulting program, having computer-readable code means, may be embodied or provided within one or more computer-readable media, thereby making a computer program product, i.e., an article of manufacture, according to the invention. For example, computer readable media may contain program instructions for a computer program code for measuring a rail wheel dimension and processing the measured wheel dimension relative to an allowable dimension. The computer readable media may also include a computer program code for predicting a remaining service life of the wheel based on a historical wear rate for the wheel being measured and the processed wheel dimension.

The computer readable media may be, for example, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will be able to combine the software created as described with appropriate general purpose or special purpose computer hardware, such as a microprocessor, to create a computer system or computer sub-system embodying the method of the invention. An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention.

It will be understood that the specific embodiment of the invention shown and described herein is exemplary only. Numerous variations, changes, substitutions and equivalents will now occur to those skilled in the art without departing from the spirit and scope of the present invention. Accordingly, it is intended that all subject matter described herein and shown in the accompanying drawings be regarded as illustrative only and not in a limiting sense and that the scope of the invention be solely determined by the appended claims.

What is claimed is:

1. A method of determining a remaining service life for a rail wheel of a railway vehicle using an electronic rail wheel wear gauge mountable on a rail wheel for measuring at least one rail wheel dimension, the method comprising:
measuring a rail wheel dimension;
processing the measured wheel dimension relative to an allowable wear dimension;
accessing a historical wheel wear rate database relating to the rail wheel; and
predicting a remaining service life of the wheel based on the historical wheel wear rate data and the processed wheel dimension.

2. The method of claim 1, further comprising measuring the rail wheel at periodic timed intervals during its life and developing the historical wear rate data based on rail wheel specific periodic measurements.

3. The method of claim 1, wherein the rail wheel is from a population of generally similar rail wheels, the method further comprising measuring the population at timed intervals to develop the historical wheel wear rate database.

4. The method of claim 1, further comprising receiving an operator identifier at the electronic rail wheel wear gauge to identify a user of the wheel gauge.

5. The method of claim 1, further comprising transmitting information indicative of a rail wheel dimension being measured to a central service monitoring center.

6. The method of claim 1, further comprising providing a display comprising indicia indicative of a sequence of rail wheel measurements to be performed.

7. The method of claim 6, wherein the railway vehicle has a plurality of rail wheels to be measured, and wherein the sequence to be performed comprises an order of measuring the plurality of wheels on the railway vehicle.

8. The method of claim 1, further comprising recording information indicative of rail wheel wear observed by an operator at the electronic rail wheel wear gauge.

9. An electronic rail wheel wear gauge for measuring dimensions of a wheel of a railway vehicle comprising:
a sensor for measuring a rail wheel dimension and generating data indicative of the rail wheel dimension; and
a processor for processing the data indicative of the measured wheel dimension relative to an allowable wear dimension and predicting a remaining service life of the wheel based on a historical wear rate for the wheel being measured and the measured wheel dimension provided by the sensor.

10. The gauge of claim 9, further comprising a memory for storing measured rail wheel dimension data for the rail wheel.

11. The gauge of claim 9, further comprising a transmitter for transmitting information indicative of a rail wheel dimension being measured to a central service monitoring center.

12. The gauge of claim 9, further comprising a display providing indicia indicative of a sequence of rail wheel measurements to be performed.

13. The gauge of claim 9, further comprising an input device for receiving an operator identifier at the electronic rail wheel wear gauge to identify a user of the gauge.

14. The gauge of claim 9, further comprising a recording device for allowing a user to record information indicative of rail wheel wear observed by the operator.

15. A method of determining a remaining service life for a rail wheel of a railway vehicle having an annular reference groove formed in a face of the wheel using an electronic rail wheel wear gauge for the rail wheel, the method comprising:
identifying a reference groove dimension indicative of a diameter of the reference groove of a rail wheel being measured;
measuring a rail wheel dimension of the rail wheel relative to the reference groove; and
determining a rail wheel diameter of the rail wheel based on the received reference groove dimension and a measured rail wheel dimension.

16. An electronic rail wheel wear gauge for measuring a rail wheel dimension relative to an annular reference groove formed in a face of the wheel comprising:
an input device for storing a reference groove dimension indicative of a diameter of the reference groove of a rail wheel being measured;
a sensor for measuring a rail wheel dimension of the rail wheel relative to the reference groove; and
a processor in communication with the sensor comprising logic for processing the measured rail wheel dimension relative to the reference groove and determining a rail wheel diameter of the rail wheel based on the stored reference groove dimension and the measured rail wheel dimension.

17. The gauge of claim 16, wherein the sensor comprises a rail wheel reference groove locator for sensing a location of the rail wheel reference groove relative to a position of the gauge when the gauge is installed on the wheel.

18. A method of verifying a need to service a wheel removed from a railway mobile asset and identified by an identifier using an electronic rail wheel wear gauge mountable on a rail wheel for measuring at least one rail wheel dimension, the method comprising:
measuring a rail wheel dimension of a wheel removed from a railway mobile asset;
processing the measured wheel dimension relative to an allowable dimension to determine if the wheel needs to be serviced; and
associating the rail wheel with an identifier to link the wheel to a locomotive from which the wheel was removed for tracking service and operational history of the rail wheel.

19. An electronic rail wheel wear gauge for measuring rail wheel dimensions of a rail wheel removed from a railway mobile asset comprising:
a sensor for measuring a rail wheel dimension;
an input device for receiving an identifier; and
a processor in communication with the sensor comprising logic for processing the measured wheel dimension relative to an allowable dimension to determine if the wheel needs to be serviced and associating the rail wheel with an identifier to associate the wheel to a locomotive from which the wheel was removed.
